(19) United States
(12) Patent Application Publication
(10) Pub. No.: US 2016/0075342 A1
(43) Pub. Date: Mar. 17, 2016

(54) DRIVING FORCE INDICATOR FOR VEHICLE

(71) Applicant: Toyota Jidosha Kabushiki Kaisha, Toyota-shi Aichi-ken (JP)

(72) Inventors: Satoshi Shimizu, Seto-shi Aichi-ken (JP); Kunihiro Iwatsuki, Toyota-shi Aichi-ken (JP)

(21) Appl. No.: 14/848,932

(22) Filed: Sep. 9, 2015

(30) Foreign Application Priority Data
Sep. 17, 2014 (JP) 2014-189371

(51) Int. Cl. B60W 50/08; B60W 50/14; B60W 10/10; B60W 10/06; B60W 30/18; B60W 30/19

(52) U.S. Cl. CPC B60W 50/085; B60W 30/18009; B60W 30/19; B60W 10/10; B60W 10/06; B60W 50/14; B60W 2050/146; B60W 2710/0644; B60W 2710/1005

(57) ABSTRACT

A driving force indicator for a vehicle is provided. The vehicle includes a transmission. The driving force indicator includes a display and at least one electronic control unit. The electronic control unit is configured to control the display such that at least a driving force of a front wheel or rear wheel of the vehicle is indicated on the display. The electronic control unit is configured to change the driving force indicated on the display in synchronization with a change in driving force of the vehicle, a change in engine rotation speed or a change in rotation speed of a predetermined rotating member, caused by shift control over the transmission. The predetermined rotating member is a component of the transmission.

### INCORPORATION BY REFERENCE

The disclosure of Japanese Patent Application No. 2014-189371 filed on Sep. 17, 2014 including the specification, drawings and abstract is incorporated herein by reference in its entirety.

### BACKGROUND OF THE INVENTION

1. Field of the Invention

The invention relates to a driving force indicator for a vehicle and, more particularly, to optimization of the timing of changing an indicated driving force during a shift.

2. Description of Related Art

In a four-wheel drive vehicle, or the like, there is suggested a system that shows a vehicle model (vehicle model image) on an in-vehicle display provided at a driver seat, or the like, and that indicates the driving force of each wheel beside a corresponding one of wheels of the vehicle model image. A torque indicator for a vehicle, described in Japanese Patent Application Publication No. 2011-46362 (JP 2011-46362 A), is one example of the system. The torque indicator for a vehicle, described in JP 2011-46362 A, includes a first display area and a second display area. A driving torque is indicated in the first display area. A braking torque is indicated in the second display area. The torque indicator for a vehicle is configured to allow a driver to recognize whether a driving force that is generated in each drive wheel is a driving torque or a braking torque by indicating the driving force in the first display area when a driving torque is generated and indicating the driving force in the second display area when a braking torque is generated.

### SUMMARY OF THE INVENTION

Incidentally, at the time when a shift is carried out in the vehicle, indicated driving forces that are indicated on the vehicle model image also change before and after the shift. If the timing of changing the indicated driving forces is inappropriate, there occurs a deviation between changes in indicated driving forces and a change in engine rotation speed on a tachometer or a change in actual driving force, so there is a possibility that a feeling of strangeness is provided to the driver.

The invention provides a driving force indicator for a vehicle, which suppresses a feeling of strangeness to a driver by suppressing a deviation between a change in engine rotation speed or a change in actual driving force and a change in indicated driving force.

A driving force indicator for a vehicle according to an aspect of the invention is provided. The vehicle includes a transmission. The driving force indicator includes a display and at least one electronic control unit. The electronic control unit is configured to control the display such that at least a driving force of a front wheel or rear wheel of the vehicle is indicated on the display. The electronic control unit is configured to change the driving force indicated on the display in synchronization with a change in driving force of the vehicle, a change in engine rotation speed or a change in rotation speed of a predetermined rotating member, caused by shift control over the transmission. The predetermined rotating member is a component of the transmission.

According to the above aspect, the indicated driving force is changed in synchronization with the change in driving force of the vehicle, the change in engine rotation speed or the change in the rotation speed of the predetermined rotating member, caused by shift control over the transmission, and the predetermined rotating member is a component of the transmission. Therefore, the indicated driving force is changed at the timing at which a driver experiences a change in driving force, so it is possible to suppress a feeling of strangeness to the driver.

In the driving force indicator according to the above aspect, the electronic control unit may be configured to determine a start of the change or end of the change in the engine rotation speed or a start of the change or end of the change in the rotation speed of the predetermined rotating member. The electronic control unit may be configured to change the indicated driving force when the electronic control unit has determined the start of the change or the end of the change. When the engine rotation speed or the rotation speed of the predetermined rotating member changes as a result of shift control or at the time when the change starts or ends, the driver recognizes the change in driving force. By changing the indicated driving force at the time when the start of the change or end of the change in engine rotation speed or the rotation speed of the predetermined rotating member is determined, there is no temporal deviation between a change in actual driving force experienced by the driver and a change in the indicated driving force, so it is possible to suppress a feeling of strangeness to the driver.

In the driving force indicator according to the above aspect, the electronic control unit may be configured to determine the start of the change or end of the change in the engine rotation speed or the rotation speed of the predetermined rotating member on the basis of an elapsed time from time at which a shift of the transmission is determined, an elapsed time from time at which a command to shift the transmission is output or an elapsed time from time at which a shift operation of the transmission is started. With this configuration, the indicated driving force is changed in response to an elapsed time from the time at which a shift of the transmission is determined, an elapsed time from the time at which a command to shift the transmission is output or an elapsed time from the time at which a shift operation of the transmission is started, so it is possible to change the indicated driving force at optimal timing without detecting a change in engine rotation speed or a change in rotation speed of the predetermined rotating member where necessary.

In the driving force indicator according to the above aspect, the electronic control unit may be configured to, during a shift, compute an engine rotation speed that is indicated during a shift, separately from an engine rotation speed that is indicated not during the shift. The electronic control unit may be configured to control the display during the shift such that the engine rotation speed that is indicated during the shift is indicated on the display. The electronic control unit may be configured to change the driving force indicated on the display in synchronization with the change in the engine rotation speed that is indicated during the shift. When the engine rotation speed that is indicated during a shift is computed separately from the engine rotation speed that is indicated not during the shift, it is desirable to change the indicated driving force in synchronization with a change in engine rotation speed that is computed as the engine rotation speed that is indicated during the shift. By changing the indicated driving force in synchronization with a change in engine rotation speed that is indicated during a shift, a deviation between a change in indicated engine rotation speed and a change in indicated driving force is suppressed, so it is possible to suppress a feeling of strangeness to the driver.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a skeletal view that illustrates the outline of a driving system for a vehicle according to an embodiment of the invention;

FIG. 2 is a functional block diagram that illustrates control functions of an electronic control unit that controls a driving state of the driving system shown in FIG. 1 and an indicated driving state;

FIG. 3 is a flowchart that illustrates a relevant portion of control operations of the electronic control unit shown in FIG. 2, that is, control operations for suppressing a feeling of strangeness to a driver by suitably changing indicated driving amounts in a vehicle model image in response to a change in driving force during a shift of an automatic transmission;

FIG. 4 is a time chart that shows one mode of an indicated driving force in a downshift of the automatic transmission shown in FIG. 1; and

FIG. 5 is a time chart that shows one mode of an indicated driving force in an upshift of the automatic transmission shown in FIG. 1.

### DETAILED DESCRIPTION OF EMBODIMENTS

Hereinafter, an embodiment of the invention will be described in detail with reference to the accompanying drawings. In the following embodiment, the drawings are modified or simplified where appropriate, and the scale ratio, shape, and the like, of each portion are not always drawn accurately.

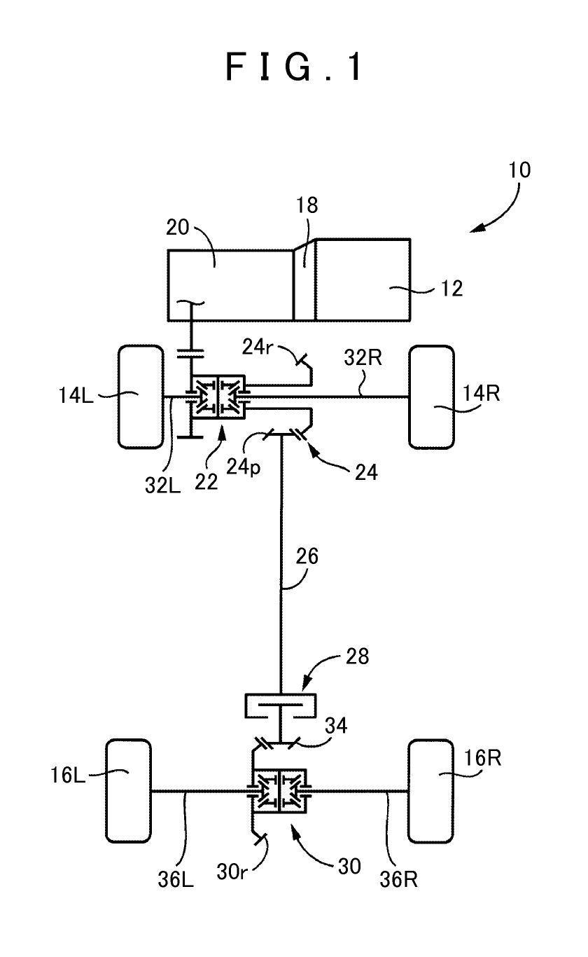

FIG. 1 is a skeletal view that illustrates the outline of a driving system 10 for a vehicle, to which a driving force indicator for a vehicle is applied, according to the embodiment of the invention. In FIG. 1, the driving system 10 is an FF-base four-wheel drive system that uses an engine 12 as a driving source. The FF-base four-wheel drive system includes two power transmission paths. One of the power transmission paths transmits the power of the engine 12 to front wheels 14R, 14L (when not particularly distinguished from each other, referred to as front wheels 14). The other one of the power transmission paths transmits the power of the engine 12 to rear wheels 16R, 16L (when not particularly distinguished from each other, referred to as rear wheels 16). The driving system 10 includes the engine 12, a torque converter 18, an automatic transmission 20, a front differential 22, a transfer 24, a propeller shaft 26, a coupling 28 and a rear differential 30.

The automatic transmission 20 is provided in the power transmission path between the engine 12 and each of the front wheels 14 and the rear wheels 16. The automatic transmission 20 is, for example, a stepped automatic transmission. The stepped automatic transmission includes a plurality of planetary gear trains and a plurality of hydraulic friction engagement devices (a clutch and a brake). The stepped automatic transmission is shifted into a plurality of speed positions by changing an engaged one of the plurality of hydraulic friction engagement devices.

The front differential 22 includes a differential mechanism. The front differential 22 is a differential unit that transmits turning force to right and left front wheel axles 32R, 32L connected to the front wheels 14 while imparting a rotation speed difference to the right and left front wheel axles 32R, 32L as needed.

The transfer 24 is provided next to the front differential 22. The transfer 24 includes a ring gear 24r and a driven pinion 24p, and transmits power to the propeller shaft 26 side. The ring gear 24r is connected to the case of the front differential 22. The driven pinion 24p is connected to the propeller shaft 26.

The coupling 28 is provided between the propeller shaft 26 and the rear differential 30. The coupling 28 is, for example, an electronically controlled coupling formed of a wet multiple disc clutch. The coupling 28 is able to continuously change the distribution of torque between the front and rear wheels within the range of, for example, 100:0 to 50:50 by controlling the torque capacity of the coupling 28. Specifically, when current is supplied to an electromagnetic solenoid (not shown) that controls the torque transmitted by the coupling 28, the coupling 28 is engaged by an engagement force directly proportional to the value of the current. For example, when no current is supplied to the electromagnetic solenoid, the engagement force of the coupling becomes zero, that is, the transmitted torque becomes zero, so the distribution of torque between the front and rear wheels is set to 100:0. When the value of current that is supplied to the electromagnetic solenoid increases and then the coupling 28 is completely engaged, the distribution of torque between the front and rear wheels is set to 50:50. In this way, the distribution of torque that is transmitted to the rear wheel side increases as the value of current that is supplied to the electromagnetic solenoid increases, so it is possible to continuously change the distribution of torque between the front and rear wheels by controlling the value of the current.

A rotating element connected to the rear wheel side of the coupling 28 is connected to a drive pinion 34. The drive pinion 34 is in mesh with a differential ring gear 30r. The differential ring gear 30r functions as an input rotating member of the rear differential 30.

The rear differential 30 includes the differential ring gear 30r. The rear differential 30 is a differential unit that transmits rotation, which is input from the differential ring gear 30r, to right and left rear wheel axles 36R, 36L connected to the rear wheels 16 while imparting a rotation speed difference to the right and left rear wheel axles 36R, 36L as needed.

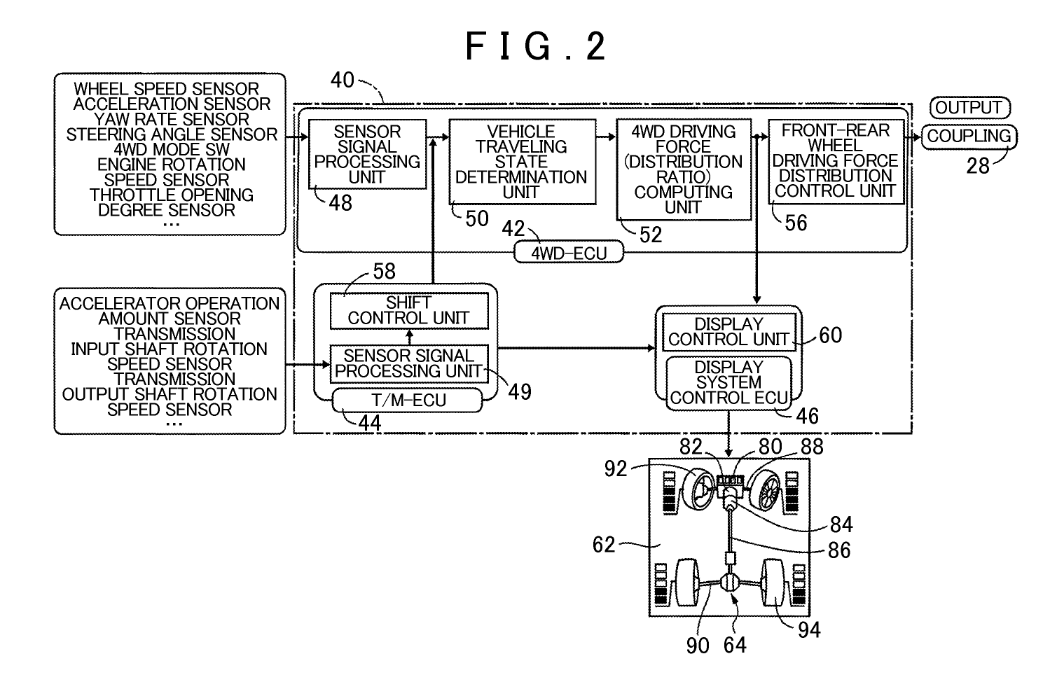

In the present embodiment, a vehicle model image 64 is shown on an in-vehicle display 62 provided at the driver seat (see FIG. 2). The vehicle model image 64 indicates the state where the driving system 10 distributes driving force between the front and rear wheels. FIG. 2 is a functional block diagram that illustrates the control functions of an electronic control unit 40 that controls a driving state of the driving system 10 and an indicated driving state. The electronic control unit 40 includes a so-called microcomputer including, for example, a CPU, a RAM, a ROM, input/output interfaces, and the like. The CPU controls the driving state of the driving system 10 in response to the traveling state of the vehicle by executing signal processing in accordance with a program stored in the ROM in advance while utilizing the temporary storage function of the RAM. The electronic control unit 40 includes a plurality of ECUs, that is, an E/G-ECU for engine control (not shown) in addition to a 4WD-ECU 42, a T/M-ECU 44 and a display system control ECU 46. The 4WD-ECU 42 is used to control the driving state of the driving system 10. The T/M-ECU 44 is used to control a shift of the automatic transmission 20. The display system control ECU 46 is used to control the display state of the vehicle model image 64 (described later).

Information that is detected by various sensors is supplied to the electronic control unit 40. For example, each wheel speed Nr, a vehicle acceleration G (including a vehicle longitudinal acceleration and a vehicle lateral acceleration), a yaw rate Y (yaw angle), a steering angle θ, a mode change signal, an engine rotation speed Ne, a throttle opening degree θth, road gradient information, an accelerator operation amount Acc, an input shaft rotation speed Nin of an input shaft of the automatic transmission 20, an output shaft rotation speed Nout of an output shaft of the automatic transmission 20, and the like, are supplied to the electronic control unit 40. Each wheel speed Nr is detected by a wheel speed sensor that detects the rotation speed of a corresponding one of the wheels. The vehicle acceleration G is detected by an acceleration sensor. The yaw rate Y (yaw angle) of the vehicle is detected by a yaw rate sensor. The steering angle θ is detected by a steering angle sensor. The mode change signal is output from a 4WD mode switch provided at the driver seat. The engine rotation speed Ne is detected by an engine rotation speed sensor. The throttle opening degree θth is detected by a throttle opening degree sensor. The road gradient information is output from a navigation system. The accelerator operation amount Acc is detected by an accelerator operation amount sensor. The input shaft rotation speed NM corresponds to a turbine rotation speed Nt. The input shaft rotation speed Nin is detected by a transmission input shaft rotation speed sensor. The output shaft rotation speed Nout corresponds to a vehicle speed V. The output shaft rotation speed Nout is detected by a transmission output shaft rotation speed sensor. A required driving force Tr, a required braking force Br, and the like, are supplied to the electronic control unit 40 from, for example, an engine ECU (E/G-ECU) (not shown) that controls the engine 12. The vehicle acceleration G may be obtained by calculating the amount of change in the vehicle speed V that is detected by a vehicle speed sensor where necessary. The driving force indicator for a vehicle according to the invention includes the electronic control unit 40 and the in-vehicle display 62. The in-vehicle display 62 displays the vehicle model image 64 (described later).

The electronic control unit 40 functionally includes a sensor signal processing unit 48, a sensor signal processing unit 49, a vehicle traveling state determination unit 50, a 4WD driving force computing unit 52, a front-rear wheel driving force distribution control unit 56, a shift control unit 58, and a display control unit 60.

In FIG. 2, the 4WD-ECU 42 functionally includes the sensor signal processing unit 48, the vehicle traveling state determination unit 50, the 4WD driving force computing unit 52 and the front-rear wheel driving force distribution control unit 56. The sensor signal processing unit 48 processes voltage signals, which are output from various sensors, as pieces of information based on the various sensors, and outputs the processed voltage signals to the vehicle traveling state determination unit 50. The vehicle traveling state determination unit 50 determines the current traveling state on the basis of the various pieces of information, processed by the sensor signal processing unit 48. Specifically, the vehicle traveling state determination unit 50 determines the traveling state of the driving system 10 on the basis of the pieces of information, such as the wheel speed Nr that is detected by each wheel speed sensor, the vehicle acceleration G that is detected by the acceleration sensor, the yaw rate Y that is detected by the yaw rate sensor, the steering angle θ that is detected by the steering angle sensor, the throttle opening degree θth that is detected by the throttle opening degree sensor, and the engine rotation speed Ne that is detected by the engine rotation speed sensor. The traveling state determination unit 50, for example, determines a slipped state of the vehicle on the basis of rotation speed differences among the wheel speeds Nr. The traveling state determination unit 50, for example, determines a side slip of the front wheels 14 or a side slip of the rear wheels 16 by comparing a target yaw rate Y*, obtained from the steering angle θ and the wheel speeds Nr, with the yaw rate that is detected by the yaw rate sensor.

The 4WD driving force computing unit 52 determines the driving force distribution ratio between the front and rear wheels upon reception of various pieces of information about the traveling state from the vehicle traveling state determination unit 50. The 4WD driving force computing unit 52 includes a map, a formula, or the like, obtained in advance for calculating the driving force distribution ratio. The map, the formula, or the like, is composed of various pieces of information about the traveling state from the vehicle traveling state determination unit 50. The 4WD driving force computing unit 52 determines an optimal driving force distribution ratio commensurate with the traveling state by reference to various pieces of information about the traveling state through the map or the formula, and then calculates a clutch torque Tc of the coupling 28. For example, when a side slip of the rear wheels 16 is large, the driving force distribution ratio is set such that the clutch torque Tc that is transmitted to the rear wheels 16 decreases; whereas, when a side slip of the front wheels 14 is large, the driving force distribution ratio is set such that the clutch torque Tc that is transmitted to the rear wheels 16 increases.

The 4WD driving force computing unit 52 calculates an engine torque Te on the basis of the engine rotation speed Ne or the throttle opening degree θth in parallel with calculation of the driving force distribution ratio. In addition, the 4WD driving force computing unit 52 computes a front wheel driving force Tf (substantially, a front wheel driving torque) of the front wheels 14 and a rear wheel driving force Tr (substantially, a rear wheel driving torque) of the rear wheels 16 from information such as a speed ratio γ of the automatic transmission 20, which is supplied from the shift control unit 58 (described later). The rear wheel driving force Tr is calculated by the following mathematical expression (1). In the mathematical expression (1), γdr corresponds to the gear ratio of the rear differential 30. The front wheel driving force Tf of the front wheels 14 is calculated by the following mathematical expression (2). In the mathematical expression (2), Tin corresponds to a torque that is output from the automatic transmission 20, and is calculated by the following mathematical expression (3). γdf corresponds to the gear ratio of the front differential 22. In the mathematical expression (3), γt corresponds to the gear ratio of the transfer 24. The 4WD driving force computing unit 52 transmits the front wheel driving force Tf and the rear wheel driving force Tr, respectively calculated by the mathematical expressions (1), (2), to a display system control ECU 46. The engine torque Te may be calculated by the E/G-ECU (not shown) that controls the engine 12, and the data of the engine torque Te may be transmitted to the 4WD driving force computing unit 52. These mathematical expressions do not take the torque ratio of the torque converter 18 into consideration; however, actually, the torque ratio of the torque converter 18 is also considered.

Tr=Tc×γdr (1)

Tf=(Tin×γdf)−Tr (2)

Tin=Tc×γ×γt (3)

The front-rear wheel driving force distribution control unit 56 controls the clutch torque Tc of the coupling 28 such that the rear wheel driving force Tr calculated by the 4WD driving force computing unit 52 is transmitted to the rear wheels 16.

The T/M-ECU 44 functionally includes the shift control unit 58 that controls a shift of the automatic transmission 20. The shift control unit 58 executes shift control, neutral control, or the like, over the automatic transmission 20. The shift control unit 58 makes a shift determination on the basis of an actual vehicle speed V and an actual accelerator operation amount Acc from a shift map obtained and stored in advance and composed of the vehicle speed V and the accelerator operation amount Acc, and then executes shift control into a predetermined speed position (speed ratio) or establishes a reverse speed position “Rev”.

The display system control ECU 46 functionally includes the display control unit 60 that controls the display state of the vehicle model image 64 provided on the in-vehicle display 62. The display control unit 60 periodically indicates the driving forces of the right and left front wheels 14 and rear wheels 16 of the driving system 10 by using the vehicle model image 64 provided on the in-vehicle display 62 on the basis of the front wheel driving force Tf and the rear wheel driving force Tr that are periodically transmitted from the 4WD driving force computing unit 52.

In the vehicle model image 64 shown in FIG. 2, a vehicle model is drawn in perspective view when the driving system 10 is viewed obliquely from the rear. Specifically, an on-screen engine 80 (which corresponds to the engine 12), an on-screen automatic transmission 82 (which corresponds to the transmission 20), an on-screen transfer 84 (which corresponds to the transfer 24), an on-screen propeller shaft 86 (which corresponds to the propeller shaft 26), on-screen front wheel axles 88 (which correspond to the front wheel axles 32), on-screen rear wheel axles 90 (which correspond to the rear wheel axles 36), on-screen right and left front wheels 92 (which correspond to the right and left front wheels 14), and on-screen right and left rear wheels 94 (which correspond to the right and left rear wheels 16) are shown. That is, graphic images corresponding to main members that constitute the driving system 10 are displayed.

The display control unit 60 indicates the driving forces of the wheels 92, 94 beside the corresponding wheels 92, 94 on the vehicle model image 64 by using segments (rectangular segments). In FIG. 2, a black segment indicates a lit state, and a white segment indicates an unlit state. As the number of the lit-state segments increases, it indicates that the driving force of the corresponding wheel is larger. For example, in FIG. 2, three of the segments beside each of the front wheels 92 are lit, and two of the segments beside each of the rear wheels 94 are lit, indicating a 4WD drive mode in which a driving force is transmitted to all the wheels. The numbers of lit segments are respectively determined on the basis of the front wheel driving force Tf and the rear wheel driving force Tr, which are calculated by the 4WD driving force computing unit 52. For example, the magnitude of driving force per one segment is set in advance, and the number of lit segments increases in proportion to a corresponding one of the front wheel driving force Tf and the rear wheel driving force Tr.

The display control unit 60 displays a turning angle of each front wheel 84 by changing the turning angle in a stepwise manner in response to the steering angle θ corresponding to a driver's steering amount, which is detected by the steering angle sensor. For example, FIG. 2 shows that the vehicle is turning to the right. As the steering angle θ increases, each front wheel is displayed at a larger turning angle. While the vehicle is traveling straight ahead, each front wheel is displayed in a straight ahead state as in the case of each rear wheel. In this way, the driver's steering amount (steering angle θ) is indicated by the turning angle of each front wheel.

As described above, the driving forces of the wheels 14, 16 are periodically computed by the 4WD driving force computing unit 52, and the calculated results are periodically indicated by segments beside the corresponding on-screen wheels 92, 94 of the vehicle model image 64 as on-screen driving forces Toutd (hereinafter, indicated driving forces Toutd). Incidentally, the front wheel driving force Tf (front wheel driving torque) and the rear wheel driving force Tr (rear wheel driving torque) that are calculated by the 4WD driving force computing unit 52 are calculated on the basis of the engine torque Te, the speed ratio γ of the automatic transmission 20, and the like. Therefore, the speed ratio γ changes as the automatic transmission 20 is shifted, so the sum of the front wheel driving force Tf and the rear wheel driving force Tr also changes. At the time of a shift, the 4WD-ECU 42 receives the speed ratio γ (speed ratio signal) from the T/M-ECU 44; however, when the speed ratio γ changes at the time when a shift of the automatic transmission 20 is determined (a command to shift the automatic transmission 20 is output), the indicated driving forces Toutd are changed at the timing of periodically changing the indicated driving forces Toutd after the time at which a shift is determined (actually, the indicated driving forces Toutd are changed at early time after the time at which a shift is determined). For this reason, there occurs a deviation between a change in actual driving force and changes in the indicated driving forces Toutd, so a feeling of strangeness may be provided to the driver. In the present embodiment, during a shift of the automatic transmission 20, the display control unit 60 resets (initializes) the periodical update timing of the indicated driving forces Toutd at the time at which a change in driving force actually occurs, while, at the same time, the speed ratio γ that is output from the T/M-ECU 44 to the 4WD-ECU 42 is changed. Thus, a change in actual driving force coincides with the timing of changing the indicated driving forces Toutd, so a feeling of strangeness to the driver is suppressed. Hereinafter, how the driving forces are indicated during a shift of the automatic transmission 20 will be described.

The shift control unit 58 of the T/M-ECU 44 determines the timing of changing the indicated driving forces Toutd such that the indicated driving forces Toutd change in synchronization with a change in actual driving force, caused by shift control over the automatic transmission 20. The shift control unit 58 determines the timing of changing the indicated driving forces Toutd in response to the type, condition, and the like, of a shift. For example, the shift control unit 58, for example, determines the optimal timing of changing the indicated driving forces Toutd on the basis of the type of a shift, the condition of a shift, or the like. The type of a shift includes an upshift and a downshift. The condition of a shift includes a manual shift, such as pedal operation or shift lever operation, and an automatic shift caused by depression of an accelerator pedal.

For example, in the case of an upshift, the shift control unit 58 determines to change the indicated driving forces Toutd at the time at which the start of the inertia phase of the automatic transmission 20 is determined. In the case of a downshift, the shift control unit 58 determines to change the indicated driving forces Toutd at the time at which the end of the inertia phase is determined The above configuration is one example. For example, even in the case of the same upshift, the timing of changing the indicated driving forces Toutd is changed as needed depending on, for example, an upshift (automatic shift) caused by depression of the accelerator pedal or a manual upshift caused by pedal operation, shift lever operation, or the like. The optimal timing of changing the indicated driving forces Toutd for each of the types or conditions of a shift is obtained by an experiment, or the like, and stored in advance, and is set to the timing at which a change in driving force occurs in any case. The reason why the start of the inertia phase or the end of the inertia phase is set for the timing of changing the indicated driving forces Toutd is because an actual driving force of the vehicle significantly changes at the start or end of the inertia phase.

When the shift control unit 58 sets the optimal timing of changing the indicated driving forces Toutd on the basis of the type or condition of a shift, the shift control unit 58 determines whether the change timing has been reached. Specifically, when a signal to make a start determination of the inertia phase or an end determination of the inertia phase is output, the shift control unit 58 determines that the change timing has been reached. Then, the shift control unit 58 instructs the display control unit 60 to initialize the timing of changing the periodically updated indicated driving forces Toutd, and changes the speed ratio γ of the automatic transmission 20, which is output to the 4WD-ECU 42, to a speed ratio γ after the shift (destination speed position). In response to this, the 4WD driving force computing unit 52 calculates the front wheel driving force Tf and the rear wheel driving force Tr based on the speed ratio γ after the shift. In addition, after the display control unit 60 initializes the timing of changing the indicated driving forces Toutd, the display control unit 60 changes the indicated driving forces Toutd on the basis of the calculated front wheel driving force Tf and rear wheel driving force Tr. Thus, the timing of a change in actual driving force coincides with the timing of changes in indicated driving forces Toutd, so a feeling of strangeness to the driver is suppressed. Because a computing time during which the front wheel driving force Tf and the rear wheel driving force Tr are computed is just a short time, the driver does not experience a feeling of strangeness caused by the computing time.

The start of the inertia phase is determined on the basis of whether a rotation speed difference ΔN (=|Nin−Nina|) exceeds a predetermined value ΔN1 set in advance. The rotation speed difference ΔN is the difference between the input shaft rotation speed Nin of the automatic transmission 20 and an input shaft rotation speed Nina before the start of the shift, which is calculated by the product (=Nout×γa) of the output shaft rotation speed Nout and a speed ratio γa before the shift. That is, when the rotation speed difference ΔN exceeds the predetermined value ΔN1, the start of the inertia phase is determined. The end of the inertia phase is determined on the basis of whether a rotation speed difference ΔN (=|Nin−Ninb|) becomes smaller than a predetermined value ΔN2 set in advance. The rotation speed difference ΔN (=|Nin−Ninb|) is the difference between the input shaft rotation speed Nin of the automatic transmission 20 and an input shaft rotation speed Ninb after the shift, which is calculated by the product (=Nout×γb) of the output shaft rotation speed Nout and a speed ratio γb after the shift. That is, when the rotation speed difference ΔN becomes smaller than the predetermined value ΔN2, the end of the inertia phase is determined The predetermined value ΔN1 and the predetermined value ΔN2 are values set in advance, and each are set to a small value to such an extent that it is possible to determine the start of the inertia phase or the end of the inertia phase. The input shaft rotation speed Nin of the automatic transmission 20 corresponds to the rotation speed of a predetermined rotating member that constitutes a transmission according to the invention.

In the above description, the shift control unit 58 determines the timing of changing the indicated driving forces Toutd by substantially determining the start of the inertia phase or the end of the inertia phase on the basis of the input shaft rotation speed Nin of the automatic transmission 20. Instead, the shift control unit 58 may determine the timing of changing the indicated driving forces Toutd on the basis of the engine rotation speed Ne. Alternatively, the shift control unit 58 may determine the timing of changing the indicated driving forces Toutd on the basis of an elapsed time ta from the time at which a shift of the automatic transmission 20 is determined (the time at which a shift command is output, the time at which a shift operation is started). More specifically, the elapsed time ta from the time at which a shift is determined (the time at which a shift command is output, the time at which a shift operation is started) to the start of the inertia phase or the end of the inertia phase is empirically obtained and stored in advance for each of the types or conditions of each shift, and the indicated driving forces Toutd are changed when the elapsed time ta that matches to the type or condition of a shift elapses from the time at which the shift is determined (the time at which a shift command is output, the time at which a shift operation is started). Even when the timing of changing the indicated driving forces Toutd is determined on the basis of the elapsed time to in this way, the indicated driving forces Toutd are changed in synchronization with a change in actual driving force of the vehicle, so a feeling of strangeness to the driver is suppressed.

There is a configuration that an on-screen engine rotation speed Ne that is indicated on the tachometer together with the vehicle model image 64 on the in-vehicle display 62 is computed separately by a computing method not during a shift and a computing method during a shift and then displayed. When the engine rotation speed Ne that is indicated during a shift is computed and indicated separately from such an engine rotation speed Ne that is indicated not during a shift, it is desirable to change the indicated driving forces Toutd in synchronization with a change in engine rotation speed that is indicated during a shift. When the engine rotation speed that is indicated during a shift is computed, it is possible to set the timing of changing the indicated driving forces Toutd so as to be synchronized with a change in the engine rotation speed that is indicated during a shift.

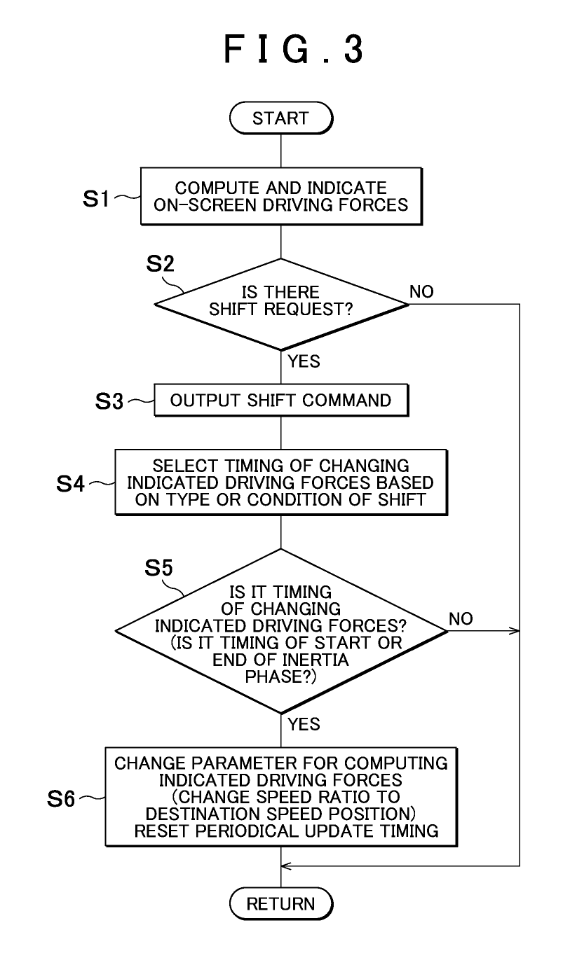

FIG. 3 is a flowchart that illustrates a relevant portion of control operations of the electronic control unit 40, that is, control operations for suppressing a feeling of strangeness to the driver by changing the indicated driving forces Toutd in the vehicle model image 64 at suitable timing during a shift of the automatic transmission 20. This flowchart is, for example, repeatedly executed at an extremely short cycle time of about several milliseconds to several tens of milliseconds.

Initially, in step S1 (hereinafter, step is omitted) corresponding to the 4WD driving force computing unit 52 and the display control unit 60, the front wheel driving force Tf and the rear wheel driving force Tr calculated by the 4WD driving force computing unit 52 are periodically updated (changed) by segments on the vehicle model image 64. This update interval (period) is sufficiently shorter than the interval (time interval) from the time at which a shift is determined (the time at which a shift command is output) to the inertia phase. In S2 corresponding to the shift control unit 58, it is determined whether there is a request to shift the automatic transmission 20 (a shift of the automatic transmission 20 is determined, a command to shift the automatic transmission 20 is output). This request to shift the automatic transmission 20 not only includes an automatic shift based on the traveling state of the vehicle (such as depression of the accelerator pedal) but also a driver's manual shift operation, such as driver's paddle operation and shift lever operation. When negative determination is made in S2, the process is returned.

On the other hand, when affirmative determination is made in S2, a command to shift the automatic transmission 20 is output in S3 corresponding to the shift control unit 58, and then the process proceeds to S4. In S4 corresponding to the shift control unit 58, the optimal timing of changing the indicated driving forces Toutd (the start of the inertia phase or the end of the inertia phase) based on the type or condition of the shift of the automatic transmission 20 is selected. In S5 corresponding to the shift control unit 58, it is determined whether the timing of changing the indicated driving forces Toutd, set in S4, has been reached. When the timing of changing the indicated driving forces Toutd has not been reached, negative determination is made in S5, and then the process is returned. On the other hand, when the timing of changing the indicated driving forces Toutd has been reached, affirmative determination is made in S5, and the process proceeds to S6. In S6 corresponding to the 4WD driving force computing unit 52, the shift control unit 58 and the display control unit 60, the speed ratio γ of the automatic transmission 20 is changed to a speed ratio after the shift. The speed ratio γ of the automatic transmission 20 is a parameter for calculating the front wheel driving force Tf and the rear wheel driving force Tr. At the same time, a command to reset the timing of changing the indicated driving forces Toutd that are periodically updated is output to the display system control ECU 46. Therefore, the front wheel driving force Tf and the rear wheel driving force Tr based on the speed ratio after the shift are calculated simultaneously with the update timing, and the indicated driving forces Toutd of the vehicle model image 64 are changed on the basis of the calculated front wheel driving force Tf and rear wheel driving force Tr, so a feeling of strangeness to the driver is suppressed.

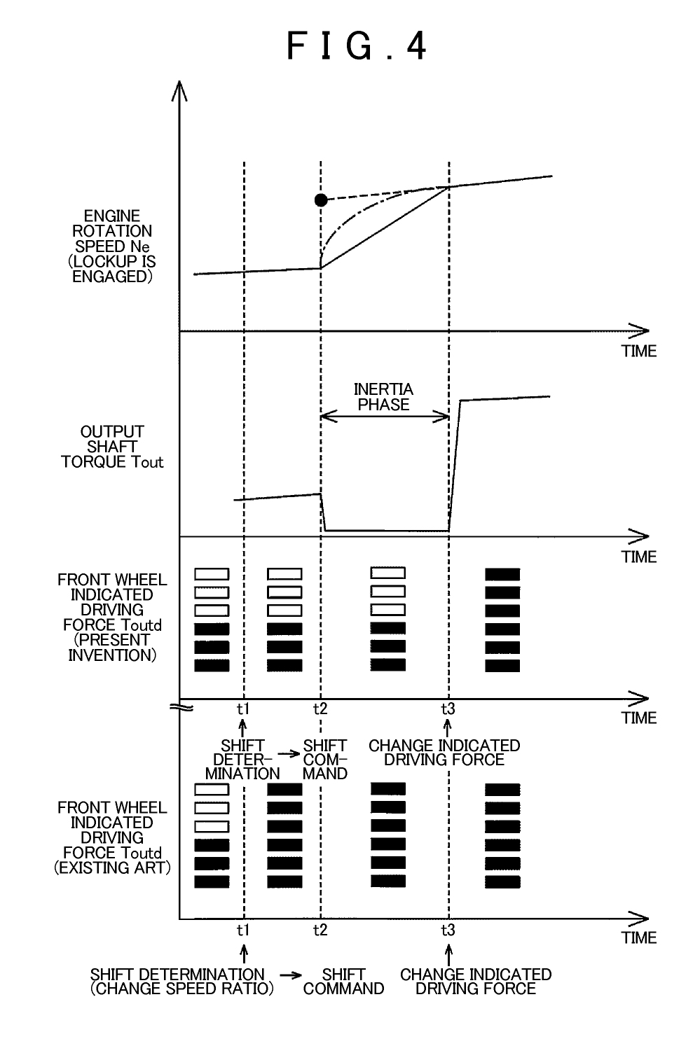

FIG. 4 is a time chart that shows one mode of the indicated driving force Toutd in a downshift of the automatic transmission 20. In FIG. 4, the abscissa axis represents time, and the ordinate axes respectively represent, in order from the top, the engine rotation speed Ne (when a lockup clutch is engaged), an output shaft torque Tout corresponding to an actual driving force, the indicated driving force Toutd (present invention) indicated by segments and an existing indicated driving force Toutd (existing art) indicated by segments as a comparison target.

When a shift is determined (a downshift is determined) and a shift command is output at time t1 shown in FIG. 4, the shift control unit 58 starts downshift control. The shift may be determined on the basis of a manual shift caused by paddle operation or shift lever operation, or an automatic shift caused by depression of the accelerator pedal. In FIG. 4, the shift is determined on the basis of a manual shift caused by paddle operation or shift lever operation. The torque of the high speed position-side clutch (release-side clutch) decreases as shift control is started. When the inertia phase is started at time t2, the engine rotation speed Ne increases. When the input shaft rotation speed Nin of the automatic transmission 20 reaches the rotation speed Nin (the end of the inertia phase) that is calculated on the basis of the speed ratio γ after a shift at time t3, the torque of the low speed position-side clutch (engagement-side clutch) is steeply increased, and a speed position after the downshift is established.

In this downshift caused by a manual shift, the time at which a change in driving force is large is the end of the inertia phase as shown in FIG. 4, and the indicated driving forces Toutd are changed at the time t3. The T/M-ECU 44 determines the time t3 at which the inertia phase ends, updates the speed ratio γ with the speed ratio after the shift at the time t3, and transmits the speed ratio after the shift to the 4WD-ECU 42. In response to this, the 4WD-ECU 42 calculates the front wheel driving force Tf and the rear wheel driving force Tr on the basis of the updated speed ratio after the shift, and transmits the front wheel driving force Tf and the rear wheel driving force Tr to the display system control ECU 46. The display system control ECU 46 changes the indicated driving forces Toutd on the vehicle model image 64 on the basis of the front wheel driving force Tf and the rear wheel driving force Tr.

The front wheel indicated driving force Toutd in FIG. 4 shows an example of the case where the indicated driving force Toutd during a shift is indicated by segments. In FIG. 4, it is assumed that the torque of the coupling 28 remains unchanged during a shift. That is, the driving force that is transmitted to the rear wheels 16 does not change before and after a shift, and the driving force that is transmitted to the front wheels 14 changes. As shown in FIG. 4, before a shift is determined (before time t1), three of segments indicating the indicated driving force Toutd of each front wheel 14 are lit. At the end (time t3) of the inertia phase, at which a change in driving force increases, the number of lit segments is changed to six. In this way, the indicated driving forces Toutd are changed at the time when a change in actual driving force occurs, so a feeling of strangeness to the driver is suppressed.

In contrast, in the existing indicated driving force Toutd, the speed ratio γ of the automatic transmission 20 is updated with a speed ratio after a shift at time t1 at which a shift is determined (a shift command is output), so the number of lit segments is changed at time t1 as shown in FIG. 4. In this way, because the indicated driving forces Toutd are changed not at time t3 at which a change in actual driving force occurs, a feeling of strangeness is provided to the driver.

As shown in FIG. 4, the actual driving force also drops at the start of the inertia phase, so it is possible to reflect the change in driving force in the indicated driving forces Toutd. In this case, the amounts of reduction in indicated driving forces Toutd are set in advance depending on the type or condition of a shift, and segments corresponding to the amounts of reduction are set to the unlit state.

The engine rotation speed Ne indicated by the black circle in FIG. 4 indicates a predicted engine rotation speed Ne after a shift. The engine rotation speed Ne indicated by the alternate long and short dashed line is an on-screen engine rotation speed Ne during a shift, which is obtained by applying first-order lag processing to the predicted engine rotation speed Ne after a shift. In this way, there is a configuration that the on-screen engine rotation speed Ne during a shift is computed and indicated on a tachometer. Not during a shift, the on-screen engine rotation speed Ne is calculated by computation different from the on-screen engine rotation speed Ne during a shift, and is indicated on the tachometer. When such an on-screen engine rotation speed Ne is computed and the on-screen engine rotation speed Ne during a shift is computed instead of the on-screen engine rotation speed Ne not during a shift, it is also possible to change the indicated driving forces Toutd during a shift in synchronization with a change in the on-screen engine rotation speed Ne that is computed during a shift. For example, the on-screen engine rotation speed Ne indicated by the alternate long and short dashed line in FIG. 4 significantly changes at time t2 that is the start of the inertia phase. In such a case, the shift control unit 58 sets time t2, at which the on-screen engine rotation speed Ne increases, for the timing of changing the indicated driving forces Toutd.

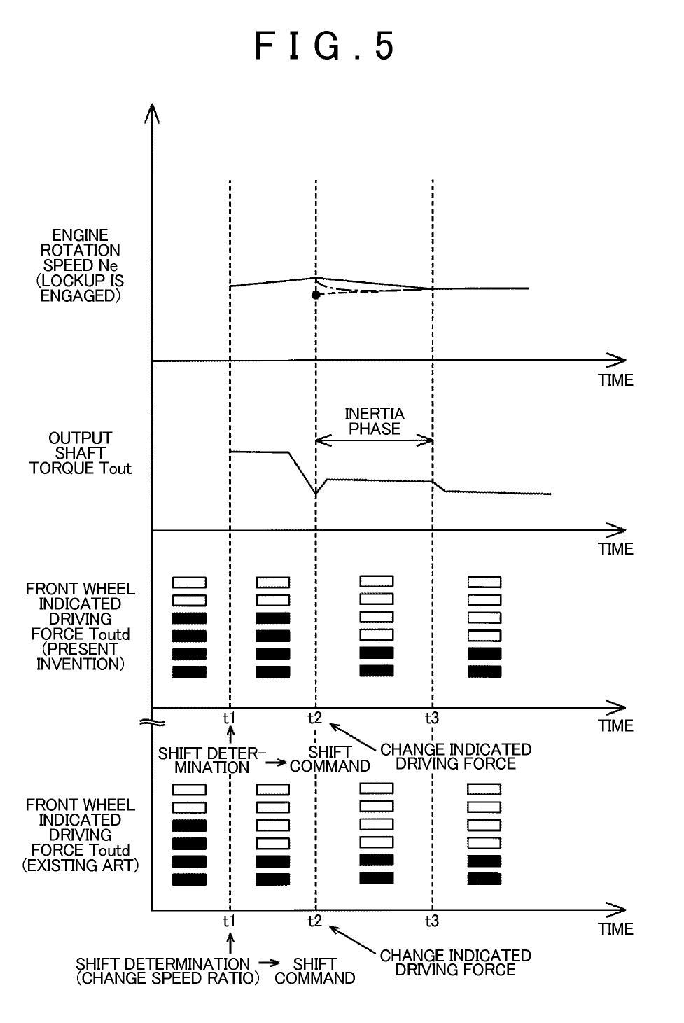

FIG. 5 is a time chart that shows one mode of the indicated driving force Toutd in an upshift of the automatic transmission 20. FIG. 5 shows the case where a change in driving force (change in speed ratio) before and after a shift is relatively small and a change in driving force at the start of the inertia phase is larger than a change in driving force at the end of the inertia phase.

When a shift is determined (an upshift is determined) and a shift command is output at time t1 shown in FIG. 5, the shift control unit 58 starts upshift control. This shift may be determined on the basis of a manual shift caused by paddle operation or shift lever operation, or an automatic shift caused by an increase in vehicle speed V. The torque of the high speed position-side clutch (engagement-side clutch) increases as shift control is started. When the inertia phase starts at time t2, the engine rotation speed Ne decreases. When the input shaft rotation speed Nin of the automatic transmission 20 reaches the rotation speed Nin (the end of the inertia phase) that is calculated on the basis of the speed ratio γ after a shift at time t3, the torque of the high speed position-side clutch (engagement-side clutch) is steeply increased, and a speed position after the upshift is established.

In the upshift shown in FIG. 5, the time at which a large change in driving force actually occurs is time t2 at which the inertia phase starts, and the indicated driving forces Toutd are changed at the time t2. The T/M-ECU 44 determines the time t2 at which the inertia phase starts, updates the speed ratio γ with the speed ratio after the shift, and transmits the speed ratio after the shift to the 4WD-ECU 42. The 4WD-ECU 42 calculates the front wheel driving force Tf and the rear wheel driving force Tr on the basis of the updated speed ratio after the shift, and transmits the front wheel driving force Tf and the rear wheel driving force Tr to the display system control ECU 46. The display system control ECU 46 changes the indicated driving forces Toutd on the vehicle model image 64 on the basis of the front wheel driving force Tf and the rear wheel driving force Tr.

The front wheel indicated driving force Toutd in FIG. 5 shows an example of the case where the indicated driving force Toutd during a shift is indicated by segments. In FIG. 5, it is assumed that the torque of the coupling 28 remains unchanged during a shift. That is, the driving force that is transmitted to the rear wheels 16 does not change before and after a shift, and the driving force that is transmitted to the front wheels 14 changes. As shown in FIG. 5, before a shift is determined (before time t1), four of segments indicating the indicated driving force Toutd of each front wheel 14 are lit. At the start (time t2) of the inertia phase, at which a change in driving force occurs, the number of lit segments is changed to two. In this way, the indicated driving forces Toutd are changed at the time t2 at which a change in actual driving force occurs, so a feeling of strangeness to the driver is suppressed.

In contrast, in the existing indicated driving force Toutd, the speed ratio γ of the automatic transmission 20 is updated with a speed ratio after a shift at time t1 at which a shift is determined (a shift command is output), so the number of lit segments is changed at time t1 as shown in FIG. 5. In this way, because the indicated driving forces Toutd are changed not at time t2 at which a change in actual driving force occurs, a feeling of strangeness is provided to the driver.

As shown in FIG. 5, the actual driving force also drops at the end of the inertia phase (time t3), so it is possible to reflect the change in driving force in the indicated driving forces Toutd. That is, the indicated driving forces Toutd may be changed in two steps. When a change in driving force at time t3 is larger than a change in driving force at time t2, it is allowed to change the indicated driving forces Toutd at time t3.

The engine rotation speed Ne indicated by the black circle in FIG. 5 indicates a predicted engine rotation speed Ne after a shift. The engine rotation speed Ne indicated by the alternate long and short dashed line is an on-screen engine rotation speed Ne during a shift, which is obtained by applying first-order lag processing to the predicted engine rotation speed Ne after a shift. In this way, there is a configuration that the on-screen engine rotation speed Ne during a shift is computed and indicated on a tachometer. Not during a shift, the on-screen engine rotation speed Ne is calculated by computation different from the on-screen engine rotation speed Ne during a shift, and is indicated on the tachometer. When such an on-screen engine rotation speed Ne is computed and the on-screen engine rotation speed Ne during a shift is computed instead of the on-screen engine rotation speed Ne not during a shift, it is also possible to change the indicated driving forces Toutd during a shift in synchronization with a change in the on-screen engine rotation speed Ne that is computed during a shift. For example, the on-screen engine rotation speed Ne indicated by the alternate long and short dashed line in FIG. 5 significantly changes at time t2 that is the start of the inertia phase. In such a case, the shift control unit 58 sets time t2, at which the on-screen engine rotation speed Ne increases, for the timing of changing the indicated driving forces Toutd.

As described above, according to the present embodiment, the indicated driving forces Toutd are changed in synchronization with a change in driving force caused by shift control over the automatic transmission 20, a change in engine rotation speed or a change in input shaft rotation speed Nin of the automatic transmission 20. Therefore, the indicated driving forces Toutd are changed at the timing at which the driver experiences a change in driving force, so it is possible to suppress a feeling of strangeness to the driver.

According to the present embodiment, generally, the driver recognizes a change in driving force at the start of the inertia phase, at which the engine rotation speed Ne or the input shaft rotation speed Nin changes, or the end of the inertia phase, at which the change ends. The indicated driving forces Toutd are changed when the start of change or end of change in the engine rotation speed Ne or input shaft rotation speed Nin is determined. Therefore, there is no temporal deviation between a change in actual driving force and changes in indicated driving forces Toutd, so it is possible to suppress a feeling of strangeness to the driver.

According to the present embodiment, the indicated driving forces Toutd are changed in response to the elapsed time to from the time at which a shift of the automatic transmission 20 is determined, the time at which a command to shift the automatic transmission 20 is output or the time at which a shift operation of the automatic transmission 20 is started. Therefore, it is possible to change the indicated driving forces Toutd at optimal timing without detecting a change in engine rotation speed or a change in input shaft rotation speed where necessary.

According to the present embodiment, when the on-screen engine rotation speed Ne during a shift is computed instead of the on-screen engine rotation speed Ne not during a shift, it is desirable to change the indicated driving forces Toutd in synchronization with a change in engine rotation speed that is computed as an on-screen engine rotation speed during a shift. By changing the indicated driving forces Toutd in synchronization with a change in on-screen engine rotation speed during a shift, a deviation between a change in on-screen engine rotation speed and changes in indicated driving forces Toutd is suppressed, so it is possible to suppress a feeling of strangeness to the driver.

The embodiment of the invention is described in detail above with reference to the accompanying drawings; however, the invention is also applicable to other embodiments.

For example, the invention is applied to the above-described driving system 10; however, the invention is not limited to this configuration. The invention is applicable as needed as long as the driving force of each wheel is indicated on a vehicle model image. For example, the invention is not always limited to a four-wheel-drive driving system. The invention is also applicable to an FF two-wheel driving system or an FR two-wheel driving system. For example, the invention is also applicable to a four-wheel-drive driving system that uses an FR driving system as a base. The invention is also applicable to, in a 4WD driving system including a propeller shaft that connects front wheels to rear wheels such that power is transmittable, a disconnection mechanism that is able to selectively connect a transfer to the propeller shaft or interrupt the transfer from the propeller shaft is provided between the transfer and the propeller shaft and a disconnection mechanism that is able to selectively connect a rear differential to the propeller shaft or interrupt the rear differential from the propeller shaft is provided between the rear differential and the propeller shaft. The invention may also be applied to a driving system including a driving force distribution mechanism that changes the distribution of right and left driving forces.

In the above-described embodiment, the automatic transmission 20 is a stepped transmission formed of a plurality of planetary gear trains; however, the structure of the transmission is not always limited to this structure. For example, the invention is applicable to a synchromesh parallel two-shaft transmission or a so-called dual clutch transmission (DCT). The synchromesh parallel two-shaft transmission includes multiple pairs of constant mesh speed gear positions between two shafts, and a shift actuator alternatively sets any one of those multiple pairs of speed gear positions to a power transmission state by using a synchronization device. The DCT is a synchromesh parallel two-shaft transmission but includes two-line input shafts, a clutch is connected to the input shaft of each line, and the two-line input shafts are respectively connected to even numbered-gear positions and odd numbered-gear positions. For a continuously variable transmission as well, the invention is applicable when stepped shift control is executed.

In the above-described embodiment, each of the indicated driving forces Toutd is indicated by the number of lit segments beside a corresponding one of the wheels; however, a configuration is applicable as needed as long as it is possible to recognize the magnitude of a driving force. For example, the magnitude of each indicated driving force Toutd may be indicated by changing the color of a segment. The magnitude of each indicated driving force Toutd may be indicated by changing the length of width of an arrow. In this way, the indicated driving force Toutd of each wheel is adequate as long as it is possible to recognize the indicated driving force Toutd on the vehicle model image 64. The indicated driving force Toutd of each wheel may be indicated on an axle connected to a corresponding one of the wheels.

In the above-described embodiment, the indicated driving forces Toutd are changed when the start or end of the inertia phase is determined; however, the indicated driving forces Toutd do not always need to be immediately changed at the start or end of the inertia phase. For example, a delay time may be set in response to the type or condition of a shift.

In the above-described embodiment, the electronic control unit 40 is formed of the plurality of processors, that is, the 4WD-ECU 42, the T/M-ECU 44 and the display system control ECU; however, the electronic control unit 40 is not always limited to this configuration. The electronic control unit 40 may be changed as needed. For example, the 4WD-ECU 42 and the T/M-ECU 44 are implemented by the same processor.

The above-described embodiment is only illustrative. The invention may be implemented in a mode including various modifications and improvements on the basis of the knowledge of persons skilled in the art.

What is claimed is:

1. A driving force indicator for a vehicle, the vehicle including a transmission, the driving force indicator comprising:
a display; and
at least one electronic control unit configured to control the display such that at least a driving force of a front wheel or rear wheel of the vehicle is indicated on the display, the electronic control unit being configured to change the driving force indicated on the display in synchronization with a change in driving force of the vehicle, a change in engine rotation speed or a change in rotation speed of a predetermined rotating member, caused by shift control over the transmission, the predetermined rotating member being a component of the transmission.

2. The driving force indicator according to claim 1, wherein the electronic control unit is configured to determine a start of the change in the engine rotation speed or a start of the change in the rotation speed of the predetermined rotating member, and the electronic control unit is configured to change the driving force indicated on the display when the electronic control unit determines the start of the change.

3. The driving force indicator according to claim 2, wherein the electronic control unit is configured to determine the start of the change in the engine rotation speed or the start of the change in the rotation speed of the predetermined rotating member on the basis of an elapsed time from time at which a shift of the transmission is determined, an elapsed time from time at which a command to shift the transmission is output or an elapsed time from time at which a shift operation of the transmission is started.

4. The driving force indicator according to claim 1, wherein the electronic control unit is configured to determine an end of the change in the engine rotation speed or an end of the change in the rotation speed of the predetermined rotating member, and the electronic control unit is configured to change the driving force indicated on the display when the electronic control unit determines the end of the change.

5. The driving force indicator according to claim 4, wherein the electronic control unit is configured to determine the end of the change in the engine rotation speed or the end of the change in the rotation speed of the predetermined rotating member on the basis of an elapsed time from time at which a shift of the transmission is determined, an elapsed time from time at which a command to shift the transmission is output or an elapsed time from time at which a shift operation of the transmission is started.

6. The driving force indicator according to claim 1, wherein the electronic control unit is configured to, during a shift, compute an engine rotation speed that is indicated during the shift, separately from an engine rotation speed that is indicated not during the shift, the electronic control unit is configured to control the display during the shift such that the engine rotation speed that is indicated during the shift is indicated on the display, and the electronic control unit is configured to change the driving force indicated on the display, in synchronization with the change in the engine rotation speed that is indicated during the shift.
